(19) United States
(12) Patent Application Publication
(10) Pub. No.: US 2015/0066565 A1
(43) Pub. Date: Mar. 5, 2015

(54) SYSTEMS AND METHODS FOR MANAGING AN INVENTORY OF COMPONENT PARTS

(71) Applicant: Kimberly-Clark Worldwide, Inc., Neenah, WI (US)

(72) Inventors: Brian L. Griebenow, Hortonville, WI (US); Thomas R. Klim, Neenah, WI (US)

(21) Appl. No.: 14/015,247

(22) Filed: Aug. 30, 2013

(51) Int. Cl. G06Q 10/06

(52) U.S. Cl. CPC G06Q 10/06315
USPC 705/7.25

(57) ABSTRACT

A method for managing a company's inventory of component parts used in a manufacturing process includes receiving a request for a recommended inventory level for a component part, accessing data corresponding to the component part, calculating a first recommended inventory level for the component part based on the data, providing, to a user, the first recommended inventory level for the component part and a predefined subset of the data comprising a usage pattern of the component part for a defined preceding period of time, receiving, from the user, a second recommended inventory level for the component part, and adjusting a current inventory level of the component part based on the second recommended inventory level.

### BACKGROUND

This invention relates generally to managing an inventory of component parts, and more specifically to systems and methods for managing a company's inventory of component parts used in a manufacturing process.

Manufacturing processes may comprise thousands of discrete parts and subassemblies, each of which will eventually require repair or replacement depending upon a myriad of factors, such as the intensity of use and environmental considerations. Process maintenance is crucial to profitability for a manufacturing company as it entails scheduling for maintenance and repairs, and ensuring that adequate parts and tools are available to carry out routine repairs as well as unplanned part replacement.

Further, the aggregate value of spare parts purchased and held in inventory to support manufacturing companies can reach into the hundreds of millions of dollars. Thus, mismanagement of these spare parts inventories carries great risks. If spare part stocks are inadequate, then the manufacturing processes cannot operate at full profit potential. However, if spare part stocks are in too much of an excess, the inventory of unneeded spare parts represents a misapplication of capital that could be otherwise used in a more effective manner.

While conventional systems and methods attempt to balance these factors using statistical analysis, there is a need for an integrated parts management system to more accurately determine spare parts ordering and distribution needs.

### SUMMARY

In one aspect, a method for managing a company's inventory of component parts used in a manufacturing process includes receiving a request for a recommended inventory level for a component part, accessing data corresponding to the component part, calculating a first recommended inventory level for the component part based on the data, providing, to a user, the first recommended inventory level for the component part and a predefined subset of the data comprising a usage pattern of the component part for a defined preceding period of time, receiving, from the user, a second recommended inventory level for the component part, and adjusting a current inventory level of the component part based on the second recommended inventory level.

In another aspect, a system for managing a company's inventory of component parts used in a manufacturing process includes a computing device. The computing device includes an interface component for exchanging data corresponding to the component parts with a user of the computing device, a memory area for storing the data, and a processor. The processor is programmed to receive a request for a recommended inventory level for a component part, access, from the memory area, data corresponding to the component part, calculate a first recommended inventory level for the component part based on the accessed data, provide, to the user, the first recommended inventory level for the component part and a predefined subset of the data comprising a usage pattern of the component part for a defined preceding period of time, receive, from the user, a second recommended inventory level for the component part, and adjust a current inventory level of the component part based on the second recommended inventory level.

In another aspect, one or more non-transitory computer-readable media having computer-executable instructions for managing a company's inventory of component parts used in a manufacturing process, the instructions causing a processor to perform the steps of receiving a request for a recommended inventory level for a component part, accessing data corresponding to the component part, calculating a first recommended inventory level for the component part based on the data, providing, to a user, the first recommended inventory level for the component part and a predefined subset of the data comprising a usage pattern of the component part for a defined preceding period of time, receiving, from the user, a second recommended inventory level for the component part, and adjusting a current inventory level of the component part based on the second recommended inventory level.

Other aspects of this disclosure will be in part apparent and in part pointed out hereinafter.

### BRIEF DESCRIPTION OF THE DRAWINGS

FIG. 1 is an exemplary block diagram of a system for managing an inventory of component parts used in a manufacturing process;

FIG. 2 is a process flow diagram of a method for managing an inventory of component parts used in a manufacturing process;

FIG. 3 is an exemplary screen shot of a graphical user interface for displaying information for recommended inventory levels for component parts;

FIG. 4 is an exemplary screen shot of a graphical user interface for displaying information for recommended inventory levels for component parts;

FIG. 5 is an exemplary screen shot of a graphical user interface for displaying information for a recommended inventory level for a component part;

FIG. 6 is an exemplary screen shot of a graphical user interface for displaying information for a recommended inventory level for a component part; and

FIG. 7 is an exemplary screen shot of a graphical user interface for displaying information for a recommended inventory level for a component part.

### DETAILED DESCRIPTION

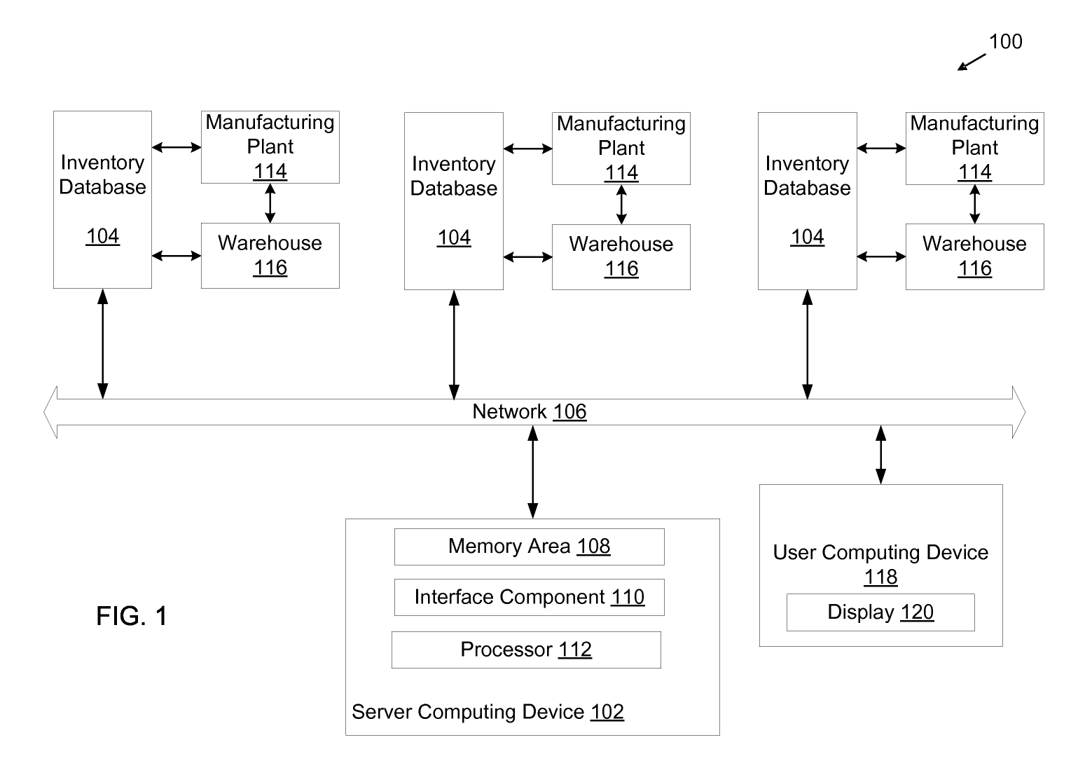

A component part inventory management system 100 embodying aspects of the present disclosure is depicted in FIG. 1. System 100 includes a server computing device 102 that is coupled to a plurality of inventory databases 104 via network 106. Network 106 is any type of network that communicatively couples computing devices. Examples of network 106 include the Internet, a peer to peer (P2P) network, a local area network (LAN), or a wide area network (WAN).

As shown in FIG. 1, each of inventory databases 104 is associated with a respective manufacturing plant 114. However, one of ordinary skill in the art will appreciate that the quantity of inventory databases 104 and manufacturing plants 114 shown in FIG. 1 are for example only and the methods described herein may be practiced with more or fewer inventory databases 104 and manufacturing plants 114 than are illustrated in FIG. 1. Further, “database” is used broadly herein so that the actual databases may comprise a combination of discrete databases, sub-databases, or alternatively a single, unified database, depending upon the specific needs and efficiencies of a particular embodiment.

Each manufacturing plant 114 may house a number of the same, or different, manufacturing processes. In one embodiment, as illustrated in FIG. 1, each manufacturing plant 114 has a warehouse 116 where stocks of spare component parts are maintained for manufacturing plants 114. Each of warehouses 116 is capable of being utilized as a central store to provide spare component parts to a number of other manufacturing plants in a single or multi-tier hub and spoke arrangement. Further, inventory databases 104, manufacturing plants 114, and warehouses 116 may be physically located any distance from one another.

A large manufacturing company will typically have many processes in operation at any given time. Additionally, that same company may be planning to bring still further manufacturing processes into operation in the future. Accordingly, the company will have a wide variety of parts required for normal operation. The systems and methods described herein can be used with any number of component parts, such as the multiple thousands of spare component parts that are commonly needed in modern manufacturing processes, and these component parts requirements can change based upon changes in the processes, such as upgrades or changes in workflow, as well as changes in the type or number of particular products that are manufactured using the processes. Additionally, as used herein, the term “spare component part” or “component part” includes any other components used in support of manufacturing processes exclusive of the product or materials produced or operated upon by the manufacturing processes. Such components can include new and used spare parts, tools, tool kits, or process subassemblies, and the number of each spare component part type that is kept in inventory may vary from zero on up.

As shown in FIG. 1, computing device 102 includes a memory area 108, an interface component 110, and at least one processor 112. However, each of memory area 108, interface component 110, and processor 112 may be separate from computing device 102.

A record of spare component parts inventory on hand for each manufacturing plant 114 is maintained in memory area 108 of server computing device 102. Memory area 108 also includes information regarding the component parts that are used in each manufacturing process at manufacturing plants 114. In one embodiment, each inventory database 104 can be updated with information from memory area 108 regarding the component parts that are presently kept in inventory at each warehouse 116 and the component parts that are used in each manufacturing process at manufacturing plants 108.

In one embodiment, to determine an inventory level of each component part and to capture descriptive data for each component part, a barcode or RFID tag is attached to each component part. As such, component parts can be scanned as they enter or leave manufacturing plants 114 and/or warehouses 116. However, while the exemplary embodiments described herein may utilize barcodes and RFID tags to facilitate tracking component parts and transmitting information regarding the tracked component parts, other data entry means may be utilized as well.

Use of barcodes and RFID enable component part information to be maintained in as high a level of detail as desired, both for component part types and particular instances of component parts. In one embodiment, for each component part, inventory database 104 can obtain and store information on, but not limited to, an acquisition date, a manufacturer, a country of origin, a model number, a manufacturer part number, a manufacturer serial number, part location data, a plant section and room, a status, a manufacturing asset number and sub-number, operation lead time offsets, cataloguing information, desired stocking levels and location such as at-plant or in a central store, a normal issue quantity, an expected plant annual usage, a plant's current safety stock, a central store's current safety stock, plant delivery time, and the like.

Once a component part is scanned, the information obtained from the barcode is sent to a respective inventory database 104 and/or memory area 108. In one embodiment, the information obtained from the bar code is initially sent to the appropriate inventory database 104 (e.g., depending upon which manufacturing plant 114 or warehouse 116 the component part was scanned in). In this example, memory area 108 may receive updates from inventory database 104 upon a request from server computing device 102 for updates, automatically after predefined time intervals (e.g., every 30 seconds, every 10 minutes, or every 24 hours), or immediately after any updates have been received by inventory databases 104. In one embodiment, manufacturing plants 114 and warehouses 116 do not have individual inventory databases 104 separate from memory area 108. In this embodiment, the information for each component part are stored in memory 108, which may include an inventory database for each of manufacturing plants 114 and warehouses 116.

Further, while memory area 108 includes a current inventory of each component part at each warehouse 116 and a current inventory of each component part used in each manufacturing process at manufacturing plants 114, memory area 108 may also include computer-executable instructions for managing an inventory of each of the component parts used in the manufacturing processes. However, in one embodiment, data corresponding to component parts and computer-executable instructions for managing an inventory of each of the component parts may be stored and executed from a memory area remote from server computing device 102. For example, one or more of component part data, manufacturing processing data, and computer-executable instructions may be stored in a cloud service, a database, or other memory area accessible by server computing device 102. Such embodiments reduce the computational and storage burden on computing server device 102. As such, memory area 108 may be a local and/or a remote computer storage media including memory storage devices.

System 100 further includes a user computing device 118 that is coupled to server computing device 102 via network 106. In one embodiment, a display 120 may be integrated into user computing device 118, for example, as a capacitive touch screen display, or a non-capacitive display. User input functionality may be provided in the display where the display acts as a user input selection device such as in a touch screen. User computing device 118 is any device capable of accessing network 106 and presenting a user interface to a user, such as a user interface provided by a stocking level application as described in further detail below. By way of example only, and not limitation, these devices include a laptop, a desktop computer, a handheld device such as an electronic book reader, a cellular phone or smart phone, or a tablet.

User computing device 118 includes a form of computer-readable media that stores, among other things, application or programs, such as the stocking level application. User computing device 118 includes a user input device (not shown) that enables a user to enter information into user computing device 118. These include, for example, a keyboard, a pointing device, or an audio input device. User computing device 118 also includes one or more output devices, such as a graphical display device or an audio output device.

Stored on the computer-readable media associated with user computing device 118 is a user interface such as, among other possibilities, a web browser. Web browsers enable a user to display and interact with a user interface and other information typically embedded on a web page or a website.

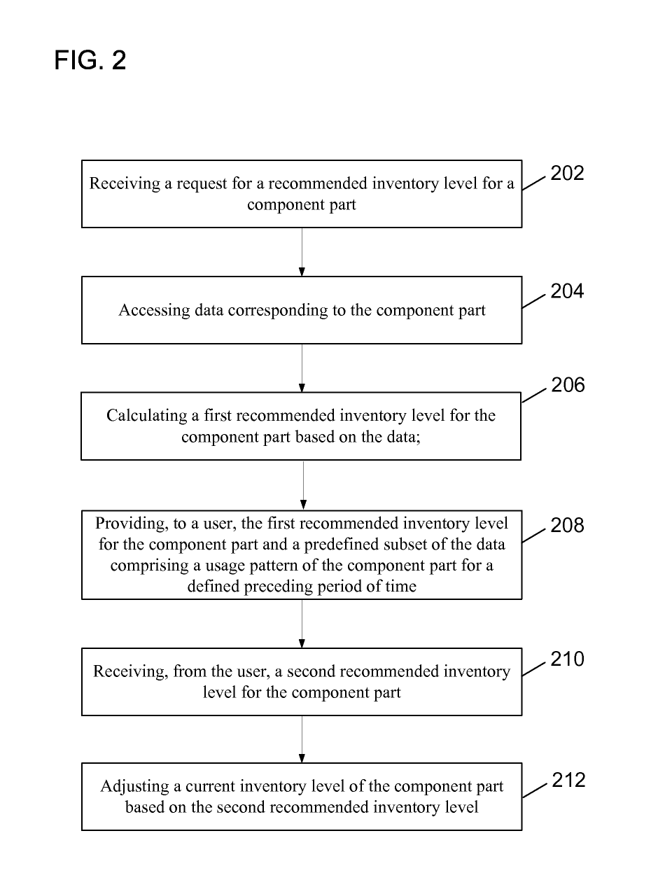

Further, processor 112 executes computer-executable instructions for implementing aspects of the disclosure. In some embodiments, processor 112 is transformed into a special purpose microprocessor by executing computer-executable instructions or by otherwise being programmed. For example, one or more computer-readable media include computer-executable instructions for instructing processor 112 to execute the steps as illustrated in FIG. 2, which will now be described in detail below.

Turning next to FIG. 2, a flow chart illustrating a method for managing an inventory of component parts used in a manufacturing process is presented. In FIG. 2, recommended inventory levels for the component parts stored in warehouses 116 (shown in FIG. 1) are generated by server computing device 102 upon a request by a user (e.g., from user computing device 118, or after a predefined period of time has elapsed (e.g., every week or every 30 days). Server computing device 102 utilizes a stocking level application (stored in memory area 108) that is based on data mining, scientific formulas, and logic parameters, such that the information used in recommending inventory levels conforms to the logic/reasoning of an individual (e.g., a Plant Technician) that is familiar with the manufacturing processes and the component parts. As such, the stocking level application, when executed by processor 112, provides recommended inventory levels that optimize the spare component part inventory working capital reduction and avoidance. In embodiments, these recommendations are thereafter provided/presented to a user (e.g., a Plant Technician that is familiar with maintenance of the component part and/or maintenance of a machine/device that uses the component part) along with pertinent information that “explains” why each of the recommendations have been made. Thus, since the user is presented with information that is easily read/understood and conforms to his/her own logic/reasoning, the user is able to comprehend the information quickly and provide adjustments to the recommendations as needed.

At 202, a request for server computing device 102 to provide recommended inventory levels for component parts stored in one or more of warehouses 116 is received by server computing device 102. As mentioned above, this may be an automatic request that is sent every month or it may be a specific request from a user. Further, the request may include a request for recommended inventory levels of all component parts stored in one or more warehouses 116, or the request may include a request for a recommended inventory level for one component part.

At 204, server computing device 102 accesses data from memory area 108 that corresponds to the applicable component parts. In one embodiment, the data includes consumption usage data, lead times (e.g., the period of time it takes to get the component part from the vendor) calculated from an actual lead time history, a calculated service factor (e.g., percentage of time a component part was available when needed), a usage quantity analysis (e.g., how many of a component part are needed at one time), a maximum historical lead time consumption (e.g., how many component parts that have been consumed during the calculated lead time), and a cost of the component part. At 206, server computing device 102 calculates a first recommended inventory level for the component parts based on the data.

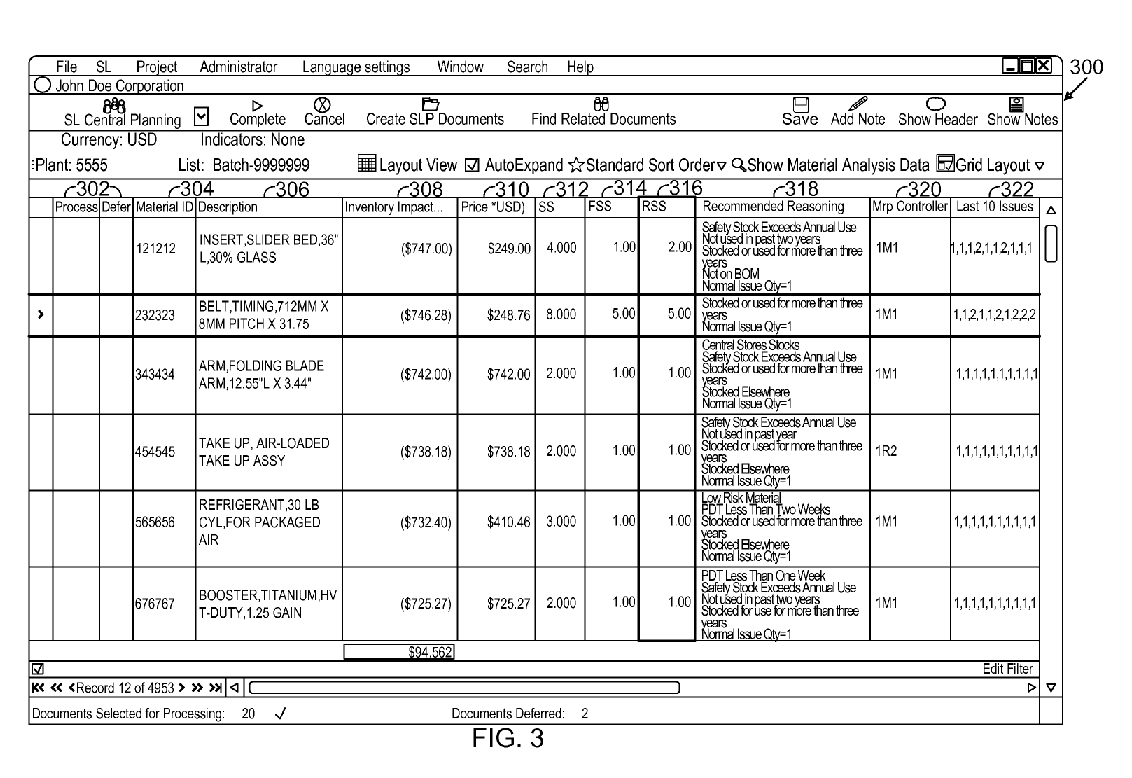

At 208, server computing device 102 provides (e.g., through interface component 110 to user computing device 118) the first recommended inventory level for the component part and a predefined subset of the data comprising a usage pattern of the component part for a defined preceding period of time (e.g., a usage pattern over the last three years), as explained in further detail below with references to FIGS. 3, 4, 5, and 6.

With reference now to FIG. 3, a screen shot of a user interface 300 for a stocking level application (SLA) is provided. User interface 300 includes a list of all stocking level optimization opportunities (e.g., recommended inventory levels) for the component parts stored at manufacturing 5555 plant (or in a warehouse associated therewith). While a list of recommended inventory levels may only include one component part, user interface 300 provides a list of every component part being stored at a specific manufacturing plant (e.g., manufacturing plant number 5555 as shown in FIG. 3). However, regardless of the number of component parts listed in user interface 300, user interface 300 is designed to provide a user with enough information to make an informed decision “at a glance” with respect to processing or deferring a recommendation for altering an inventory level. For example, at 302, a user can process or defer each of the listed recommendations by selecting an appropriate box. At 304, a material ID indicates a specific component part. At 306, a brief description of the component part is provided. At 308, a monetary value provides an indication as to how much inventory working capital would be reduced if the recommendation is processed. At 310, a cost of the component part is provided. At 312 a target stocking level (e.g., a current Safety Stock “SS”) of the component part is provided. At 314, a calculated appropriate stocking level (e.g., a Formula Safety Stock “FSS”) is provided. At 316 a Recommended Safety Stock (RSS) is provided. In one embodiment, the RSS may be the same as the FSS or it may be adjusted prior to making the recommendation. At 318, reasons for the recommendations listed in user interface 300 are provided. As mentioned above, a reason for the recommendations does not include all of the information that was used to provide the recommendation, but the information at 318 is information the user reviewing these recommendations finds key to making a recommendation. That is, the information provided at 318 may be predefined by the user reviewing the recommendations or the information is selected by the stocking level application. As such, a user reviewing the recommended reasoning at 318 understands the recommendation very quickly and can process or defer accordingly. At 320, the material requirement planning “MRP” Controller provides an indication as to which MRP group the component part is assigned to. In one embodiment, any stocked component part that is managed and procured using an MRP process is assigned to a specific MRP group appropriate to the way the component part is to be managed. At 322, a list of the number of the component part issued for the last ten issues is provided.

The list of recommendations is reviewed by a user (e.g., a Central Planner) and specific line items (e.g., stocking level change recommendations to be processed) are selected, and sent to a Plant Coordinator. The Plant Coordinator then views the month's stocking level application recommendations and forwards these recommendations to an appropriate Plant Technician for a final review.

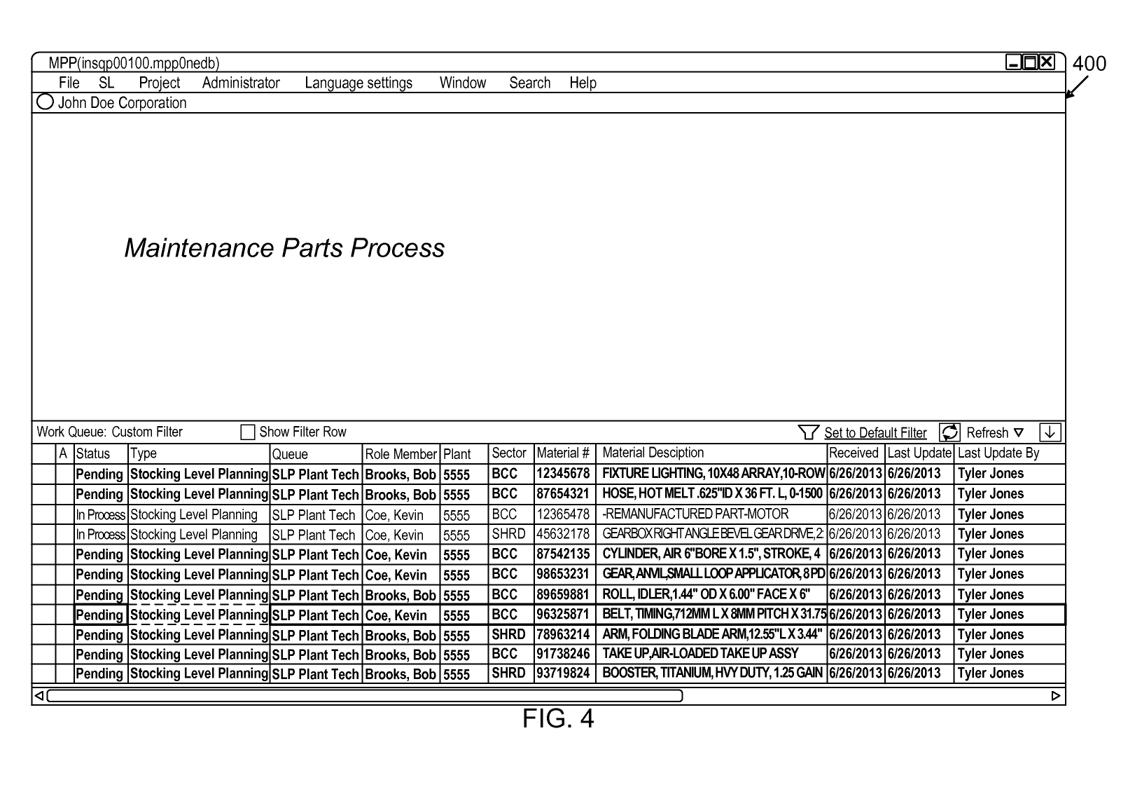

With reference now to FIG. 4, a screen shot of a user interface 400 for a spare component parts management system (e.g., “Maintenance Parts Process” or “MPP”) in which stocking level application resides is shown. User interface 400 provides an opening screen that enables a user (e.g., a Plant Technician) to select and open each recommendation listed.

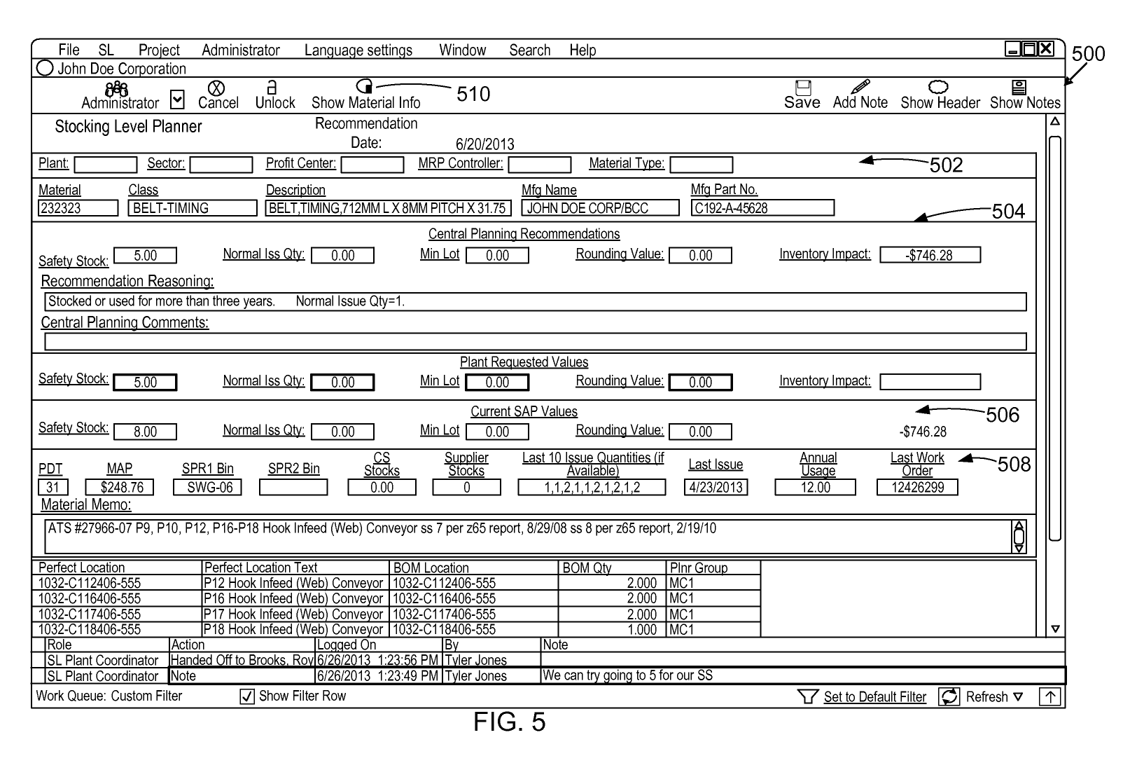

FIG. 5 is a screen shot of a user interface 500 for the stocking level application. User interface 500 provides a single stocking level application recommendation document as opened by, for example, a Plant Technician. User interface 500 provides information that is useful in helping the Plant Technician determine whether to accept the recommendation (i.e., first recommended level). User interface 500 displays this information in sections related to general material information 502, recommended changes 504, current stocking level settings 506, and mores specific general information 508.

The Plant Technician can accept the recommendation as is, or reject the recommendation and provide an alternate strategy. However, if a Plant Technician wants more information to better understand the reasoning behind the recommendation, the “Show Material Info” button at 502 may be selected.

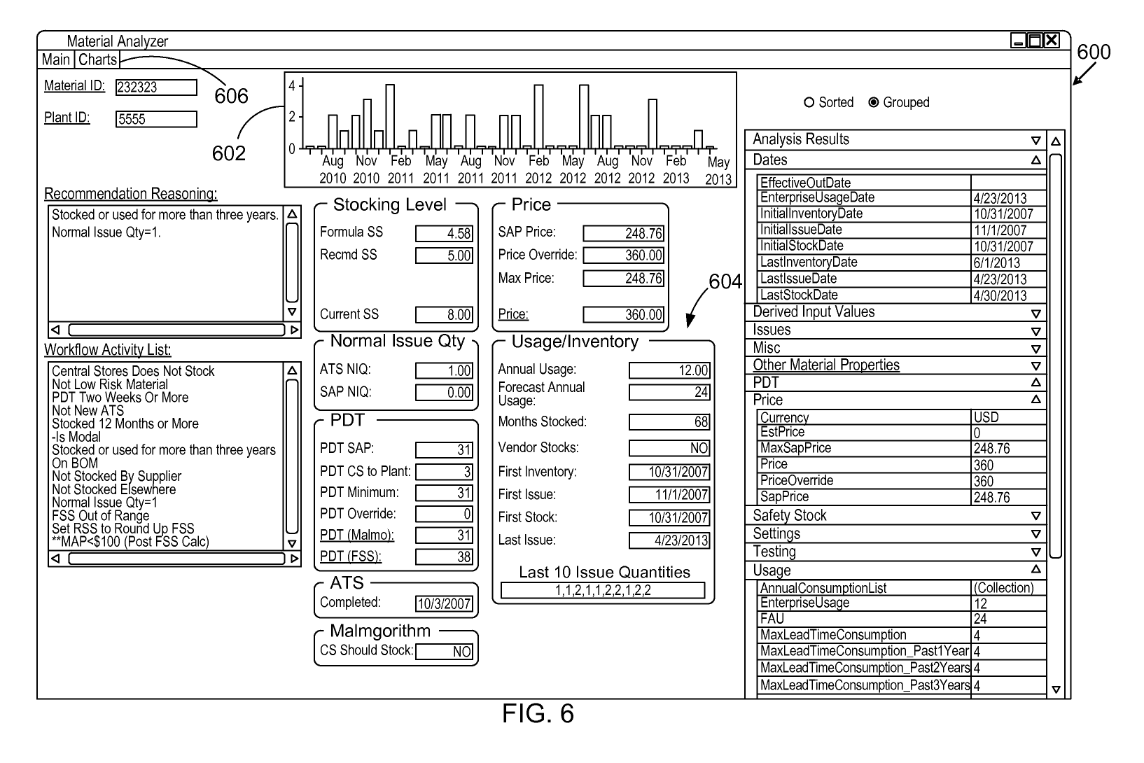

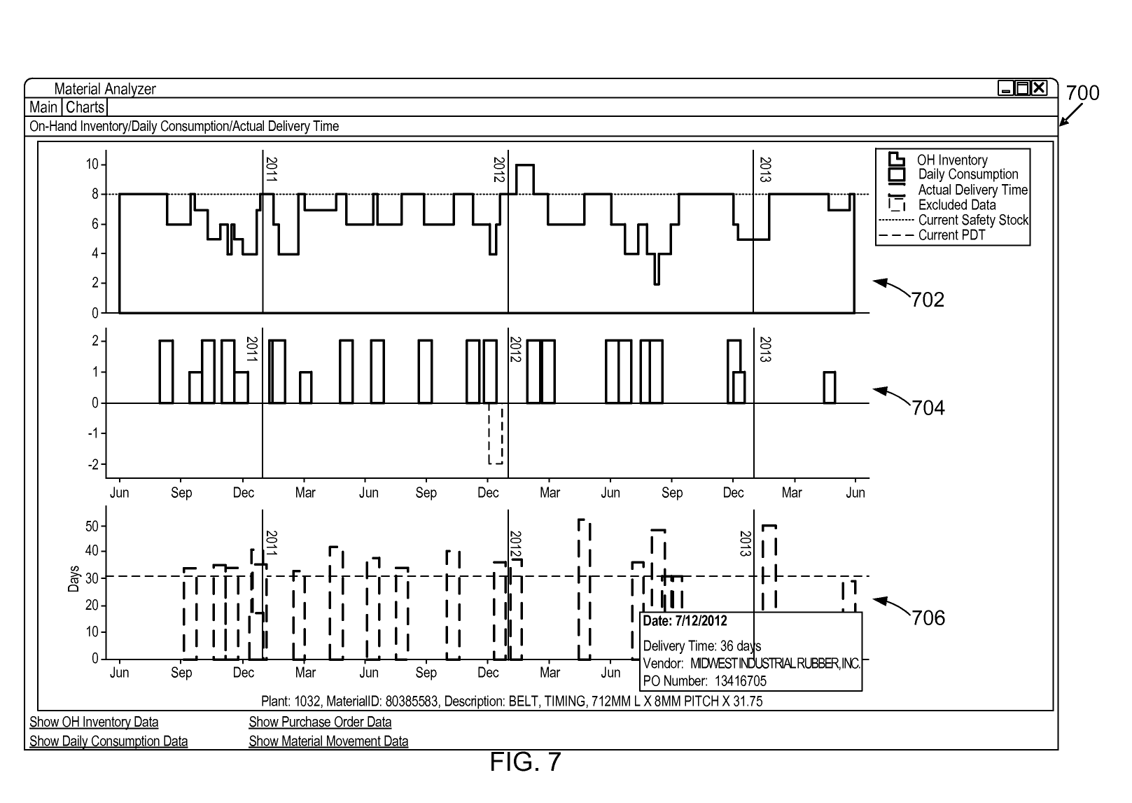

FIG. 6 is a screen shot of a user interface 600 for the stocking level application. User interface 600 presents detailed information relevant to understanding how/why the recommendation was made in order for a user to understand recommendations at a glance. For example, a graph 602 represents a monthly consumption/usage of a specific component part is provided. Each column shown in graph 602 is one month, with graph 602 spanning back 3 years. Dates related to a first date a mill stocked the component part, the first and last date the component part was issued etc. can all be found at 604. User interface 600 may also show a maximum quantity of the component part used at this particular mill within any window of time equal to the lead time of the part (e.g., how long it takes to purchase/receive the component part from a vendor), how many other mills stock and/or used this component part, and the like. A second tab 606 (e.g., the “Charts tab”) can be selected to view other helpful visuals, as shown in FIG. 7.

With reference now to FIG. 7, a screen shot of user interface 700 for the stocking level application is provided. User interface 700 includes three charts, an on-the-shelf inventory chart 702, a daily consumption quantity chart 704, and a purchase order history chart 706, which may also include where the component part originated from (e.g., a component part may ordered from one of the other manufacturing plants within the company and/or an outside manufacturer or supplier (i.e., manufacturer or supplier external from the company) of the component part). On-the-shelf inventory chart 702 displays actual on-the-shelf inventory of a specific material, as it was every day for predefined preceding time period, for example, the past 3 years. Line 708 indicates current “safety stock” (target stocking level) setting. Daily consumption quantity chart 704 shows daily consumption quantities of this material over the past 3 years. In one embodiment, hovering a curser over (e.g., a “mouse over”) any date displays detail information about that consumption. For example, the date of the consumption, a list of discrete movements (e.g., movement representing an issuance of stock from inventory), the movement code (e.g., indicating type of consumption), and quantity issued out for each movement may be displayed. Purchase order history chart 706 shows purchase order history for the past 3 years. Each hashed bar 710 represents a purchase of this material from a vendor, and how long it took to get the material. Hovering a cursor over any bar displays detail info about that purchase order. For example, a purchase order number, a name of vendor, a date received, and a delivery time from date of order placement to date of receipt may be displayed.] The four links at 712 (e.g., “show OH inventory data”, “show Purchase Order Data”, Show Daily Consumption Data“, and “Show Material Movement Data”) open yet more detail information about consumption, inventory levels, and purchases.

With reference back to FIG. 2, after the user (e.g., a Plant Technician”) has completed a review of the recommended inventory level along with the data and reasoning behind the recommendation, at 210 the user can provide a recommended inventory level (i.e., second recommended level) for the component part. In one embodiment, the recommended inventory level for the component part provided by the user/Plant Technician may be the same as the initial recommended inventory level provided by the stocking level application in FIG. 3 (e.g., the user agrees with the original recommended inventory level). If, however, the user disagrees with the original recommended inventory level, the user may provide a new/revised recommended inventory level. At 212, the current inventory level of the component part is adjusted based on the recommended inventory level provided by the user. In one embodiment, the user seeks approval for any changes made to original recommended inventory level prior to the current inventory level being adjusted.

It will be appreciated that details of the foregoing embodiments, given for purposes of illustration, are not to be construed as limiting the scope of the present disclosure. Although only a few exemplary embodiments of this disclosure have been described in detail above, those skilled in the art will readily appreciate that many modifications are possible in the exemplary embodiments without materially departing from the novel teachings and advantages of this disclosure. For example, features described in relation to one embodiment may be incorporated into any other embodiment of the invention.

Accordingly, all such modifications are intended to be included within the scope of this disclosure, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present disclosure.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description shall be interpreted as illustrative and not in a limiting sense.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the disclosure are operational with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Aspects of the disclosure transform a general-purpose computer into a special-purpose computing device when configured to execute the instructions described herein.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

What is claimed is:

1. A method for managing a company's inventory of component parts used in a manufacturing process, the method comprising:
receiving a request for a recommended inventory level for a component part;
accessing data corresponding to the component part;
calculating a first recommended inventory level for the component part based on the data;
providing, to a user, the first recommended inventory level for the component part and a predefined subset of the data comprising a usage pattern of the component part for a defined preceding period of time;
receiving, from the user, a second recommended inventory level for the component part; and
adjusting a current inventory level of the component part based on the second recommended inventory level.

2. The method of claim 1, wherein at least a portion of the manufacturing process is performed at a first manufacturing plant within the company; and wherein receiving a request to provide a recommended inventory level for a component part comprises receiving a request to provide a recommended inventory level for a component part for the first manufacturing plant.

3. The method of claim 2, wherein the data corresponding to the component part comprises: a current inventory level of the component part at the first manufacturing plant, a current inventory level of the component part at other manufacturing plants within the company, and historic data of the component part for the defined preceding period of time.

4. The method of claim 3, wherein the historic data comprises a usage of the component part over the defined preceding period of time, a consumption of the component part over the defined preceding period of time, and a length of time it took to receive the component part at the first manufacturing plant after each time the component part was ordered over the defined preceding period of time.

5. The method of claim 4, wherein the component part is ordered from one or more of the following: one of the other manufacturing plants within the company, and an outside manufacturer or supplier of the component part.

6. The method of claim 1, further comprising:
generating, from the data, a consumption pattern of the component part for the defined preceding period of time; and
providing, to the user, the generated consumption pattern of the component part for the defined preceding period of time.

7. The method of claim 1, wherein the second recommended inventory level is the same as the first recommended inventory level.

8. The method of claim 1, wherein the user is an operator or technician of a machine that uses the component part.

9. A system for managing a company's inventory of component parts used in a manufacturing process, the system comprising:
a computing device comprising an interface module for exchanging data corresponding to the component parts with a user of the computing device;
a memory area for storing the data; and
a processor programmed to:
receive a request for a recommended inventory level for a component part;
access, from the memory area, data corresponding to the component part;
calculate a first recommended inventory level for the component part based on the accessed data;
provide, to the user, the first recommended inventory level for the component part and a predefined subset of the data comprising a usage pattern of the component part for a defined preceding period of time;
receive, from the user, a second recommended inventory level for the component part; and
adjust a current inventory level of the component part based on the second recommended inventory level.

10. The system of claim 9, wherein at least a portion of the manufacturing process is performed at a first manufacturing plant within the company; and
wherein receiving a request to provide a recommended inventory level for a component part comprises receiving a request to provide a recommended inventory level for a component part for the first manufacturing plant.

11. The system of claim 10, wherein the accessed data corresponding to the component part comprises: a current inventory level of the component part at the first manufacturing plant, a current inventory level of the component part at other manufacturing plants within the company, and historic data of the component part for the defined preceding period of time.

12. The system of claim 11, wherein the historic data comprises a usage of the component part over the defined preceding period of time, a consumption of the component part over the defined preceding period of time, and a length of time it took to receive the component part at the first manufacturing plant after each time the component part was ordered over the defined preceding period of time.

13. The system of claim 12, wherein the component part is ordered from one or more of the following: one of the other manufacturing plants within the company, and an outside manufacturer or supplier of the component part.

14. The system of claim 9, wherein the processor is further programmed to:
generate, from the data, a consumption pattern of the component part for the defined preceding period of time; and
provide, to the user, the generated consumption pattern of the component part for the defined preceding period of time.

15. The system of claim 9, wherein the second recommended inventory level is the same as the first recommended inventory level.

16. One or more non-transitory computer-readable media having computer-executable instructions for managing a company's inventory of component parts used in a manufacturing process, the instructions causing a processor to perform the steps of:
receiving a request for a recommended inventory level for a component part;
accessing data corresponding to the component part; calculating a first recommended inventory level for the component part based on the data;
providing, to a user, the first recommended inventory level for the component part and a predefined subset of the data comprising a usage pattern of the component part for a defined preceding period of time;
receiving, from the user, a second recommended inventory level for the component part; and
adjusting a current inventory level of the component part based on the second recommended inventory level.

17. The non-transitory computer-readable media of claim 16, wherein at least a portion of the manufacturing process is performed at a first manufacturing plant within the company; and
wherein receiving a request to provide a recommended inventory level for a component part comprises receiving a request to provide a recommended inventory level for a component part for the first manufacturing plant.

18. The non-transitory computer-readable media of claim 17, wherein the data corresponding to the component part comprises: a current inventory level of the component part at the first manufacturing plant, a current inventory level of the component part at other manufacturing plants within the company, and historic data of the component part for the defined preceding period of time.

19. The non-transitory computer-readable media of claim 18, wherein the historic data comprises a usage of the component part over the defined preceding period of time, a consumption of the component part over the defined preceding period of time, and a length of time it took to receive the component part at the first manufacturing plant after each time the component part was ordered over the defined preceding period of time.

20. The non-transitory computer-readable media of claim 16, wherein the instructions further cause the processor to perform the steps of:
generating, from the data, a consumption pattern of the component part for the defined preceding period of time; and
providing, to the user, the generated consumption pattern of the component part for the defined preceding period of time.
